(19) United States
(12) Patent Application Publication
(10) Pub. No.: US 2018/0172435 A1
(43) Pub. Date: Jun. 21, 2018

(54) A MEASURING APPARATUS FOR MEASURING PROPERTIES OF A SURFACE

(71) Applicants: University College London, London (GB); Airbus Operations Limited, Bristol (GB)

(72) Inventors: Stuart Robson, London (GB); Ben Sargeant, London (GB); Abdul Rahman El-Nounu, Bristol (GB)

(73) Assignees: University College London, London (GB); Airbus Operations Limited, Bristol (GB)

(21) Appl. No.: 15/577,209

(22) PCT Filed: May 27, 2016
(86) PCT No.: PCT/GB2016/051555

§ 371 Date: Nov. 27, 2017

(30) Foreign Application Priority Data
May 27, 2015 (GB) 1509057.4

(51) Int. Cl. G01B 11/24; G01B 5/00; G01K 1/14; G01B 21/20; G01B 5/28

(52) U.S. Cl. CPC G01B 11/24; G01B 5/0004; G01B 5/28; G01B 21/20; G01K 1/143

(57) ABSTRACT

The present invention provides a measuring apparatus (200) for measuring properties of a surface (101, 103), the apparatus (200) comprising a mounting structure (210) comprising a plurality of segments (211-216) moveably mounted (217) with respect to each other, an actuation mechanism to move the segments of the mounting structure with respect to each other, and a plurality of sensors (220), each sensor being mounted to a segment of the mounting structure (210). The invention also provides a method of measuring properties of a surface (101, 103). The surface (102, 103) to be measured may be an aerodynamic surface of an aircraft.

### BACKGROUND OF THE INVENTION

The present invention concerns a measuring apparatus for measuring properties of a surface. More particularly, but not exclusively, this invention concerns a measuring apparatus comprising a plurality of sensors, each sensor being mounted to a mounting structure. The invention also concerns a method of measuring properties of a surface.

It is important to be able to measure properties of a surface, for example the waviness/smoothness of a surface, especially on aerodynamic devices, such as aircraft wings. This is because it is important to be able to ensure the surface meets the laminar flow requirements that it was designed for. Various methods of measuring the surface properties are known, such as stereo lithography fringe projection and photogrammetry.

For example, in stereo lithography fringe projection methods, light fringes are projected onto the surface to be measured. These are deflected/distorted by the surface and reflected back. These reflections are detected and analysed to model the surface profile.

In stereo photogrammetry, a physically paired pair of cameras are used to reconstruct a 3D image of the surface by resolving the scale and shape of the surface. The paired cameras are moved to different locations over the surface to build up a surface profile of the whole surface. Surface features (for example, from placing targets on the surface or from projecting patterns onto the surface, known as “target tracking”) are used to “join” the sets of images together.

Another method measures the dimensions of a tube by placing it in a measurement cell. The measurement cell has, for example, 16 cameras inside it and each camera takes an image of the tube from the camera's known position and angle. The images taken are then correlated to produce a 3D image of the tube.

However, these methods have their draw backs. Firstly, stereo lithography is time consuming and therefore expensive. For example, it can 30 seconds to measure one small area and can take up to about 2 days to measure a surface of an aircraft wing. Photogrammetry can also take time, especially if the resolution required is high and the surface area is large. Also, the “tube inspect” method does not allow accurate measurement of a surface profile.

The present invention seeks to mitigate the above-mentioned problems. Alternatively or additionally, the present invention seeks to provide an improved measuring apparatus.

### SUMMARY OF THE INVENTION

The present invention provides, according to a first aspect, a measuring apparatus for measuring properties of a surface, the apparatus comprising a mounting structure comprising a plurality of segments moveably mounted with respect to each other, an actuation mechanism to move the segments of the mounting structure with respect to each other, and a plurality of sensors, each sensor being mounted to a segment of the mounting structure.

By mounting the sensors on moveable segments, this means that many sensor reading can be taken at one time and then the segments can be moved to allow the sensors to have different relative positions. This allows a large number of e.g. images, over a large surface area, to be taken quickly and, when the sensors are located near to the surface, a high amount of accuracy/resolution can be achieved, whilst using low cost sensors and not being too time consuming. In addition, the apparatus can “know” where the different segments (and therefore sensors) are relative to each other at the time of data capture and so can “piece” together the different data from the different sensors. This is known as “registration”—in other words, the apparatus has the relative positions of the sensors registered.

In the context of the invention, “measurement” includes any taking of data (including taking images) that can be later used to make an assessment of a certain quantity or feature.

In use, the actuation mechanism can be used to move the plurality of segments in relation to each other.

Preferably, the mounting structure is supported by a support base and wherein the support base is moveable so that the mounting structure can be swept over the surface being measured. This allows the sensors to take a number of images as they are swept over the surface.

Preferably, the actuation mechanism controls movement of the segments based on the swept position of the mounting structure. This allows the angle/position of the sensors to be adapted based on the location of the sensors over the surface and therefore, allows the sensors to be optimised for different surface features. In particular, the position of the sensors can be arranged to match the profile of the surface at each location and/or to be a required distance from the surface based on the required accuracy/resolution and/or required data quality at that location.

Preferably, the measuring apparatus further comprises a position tracking mechanism for tracking the positions of the segments with respect to each other. This allows for the position/angle of the segments, and therefore the sensors, to be known so that the relative positioning of the sensors can be used in analysing the measurements made by the sensors.

The position tracking mechanism may be provided by the actuation mechanism.

Alternatively, the positioning tracking mechanism may be provided by an external tracking device, external to the measuring apparatus.

The position tracking mechanism allows the segments to have a defined geometry in each different configuration. This negates the need for any “target tracking” of the surface to correlate the data from the different sensors.

Preferably, the segments are pivotally mounted with respect to each other.

Preferably, the segments are moveably connected to each other at their ends to form an articulated arm. The segments may form part of a robotic arm.

Preferably, the mounting structure comprises a frame structure wherein the segments are moveably mounted to the frame structure.

Preferably, at least one segment is provided with at least two sensors. This allows the sensors to work as a stereo pair, with a fixed distance (and angle) between them. This means that the positioning of the sensors relative to each other does not have to be tracked or monitored. It also means the resultant measurements are more accurate and take less post-processing to assess.

More preferably, the two sensors are provided towards opposite ends of the segment.

Preferably, the sensors are movably mounted on the segments.

More preferably, the sensors are pivotally mounted on the segments. The sensors may be pivoted so as to be angled towards/away from each other, to give a tighter or a looser overlap of surface area. The sensors may alternatively or additionally be pivoted so as to be angled (twisted) towards/away from the axis between the sensors, to give a “sideways” view of the surface, away from the axis of the segments.

Preferably, the sensors are sensors for measuring surface dimensions. For example, the sensors may be cameras.

More preferably, the sensors are sensors for measuring the smoothness/waviness of a surface. The sensors may be sensors for measuring discontinuities, such as steps, gaps or fasteners, on a surface. The sensors may be able to measure discontinuous features and/or continuous features.

Preferably, the measuring apparatus further comprises a lighting rig for illuminating the surface being measured. The lighting rig may be attached to one or more segments or one or more sensors.

Alternatively, the sensors are sensors for measuring temperature.

Preferably, the measurement apparatus further comprises a trigger mechanism for triggering the sensors to make a measurement.

More preferably, the trigger mechanism is arranged to trigger the sensors when the mounting structure is moved into one or more required sweep positions. This ensures that sensors take measurements when at the required location on the surface.

According to a second aspect of the invention there is also provided a method of measuring properties of a surface, the method comprising the steps of providing a surface whose properties are to be measured, providing a measuring apparatus comprising a mounting structure and a plurality of sensors mounted on the mounting structure, providing the mounting structure in a first sweep position with respect to the surface, providing the sensors in a first configuration with respect to each other, using the sensors to take measurements of the surface when in the first configuration and when the mounting structure is in the first sweep position, sweeping the mounting structure over the surface from the first surface position to a second surface position, the second position being different to the first position, moving the sensors to a second configuration with respect to each other, the second configuration being different to the first configuration, and using the sensors to take measurements of the surface when in the second configuration and when the mounting structure is in the second sweep position.

Having different sensor configurations allows different positions/angles of the sensors.

Preferably, the method further comprises the step of transferring measurement data from the sensors to a computer to be processed. The computer may perform post-processing to determine measurements about the surface, such as its shape and level of waviness/smoothness. The computer may be provided with a set of criteria and may produce a pass/fail result for the surface based on the comparison of the measurements and the criteria.

Preferably, the surface to be measured is an aerodynamic surface of an aircraft, such as a wing, horizontal tail plane, vertical tail plane (fin), aileron, flap, rudder or any other aerodynamic surface feature.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a side view of one segment of a measuring apparatus according to a first embodiment of the invention; and

FIG. 2 shows a side view of part of a mounting structure, comprising a plurality of segments of FIG. 1, the measuring apparatus shown measuring a surface of leading edge and top surface of an aircraft wing.

### DETAILED DESCRIPTION

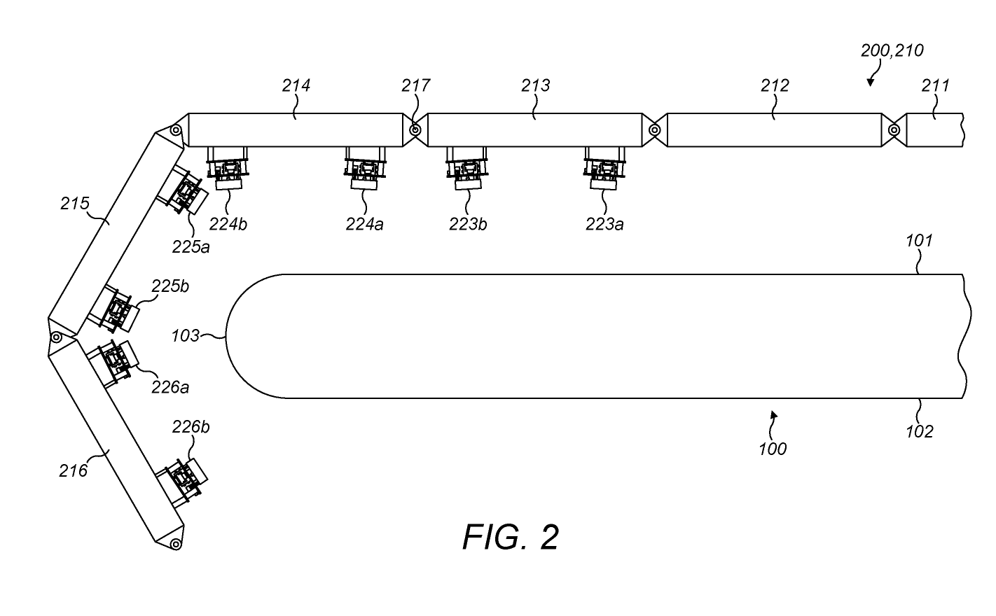

FIG. 2 shows a side view of part of a measuring apparatus 200. The apparatus 200 is being used to measure the surface waviness of a leading edge 103 and top surface 101 of an aircraft wing 100. The wing also comprises a bottom surface 102 which is not being measured.

The measuring apparatus 200 comprises a number of rigid links, six of which, 211 to 216, are shown. The links are connected together at their ends by a pivot mount 217 to form a configurable robotic arm 210. The robotic arm 210 provides a mounting structure (comprising the links) for mounting cameras 220 to, as will be described later.

The robotic arm 210 is configured (i.e. the links are pivoted with respect to each other) to form a shape that approximately corresponds to the profile of the wing surface being measured. The distance of the arm from the surface is determined by the level of accuracy/resolution required and the quality of the lenses/cameras 220 being used.

The robotic arm also includes an actuation mechanism 230 (not shown as provided internal to the robotic arm) for actuating movement of the links with respect to each other. The shape of the arm 210 (as a result of actuation of movement of the links) changes depending on where on the wing the arm 210 is located. An internal positioning tracking mechanism (not shown as part of the actuation mechanism) monitors the relative position of the links to each other.

The apparatus also comprises a trigger mechanism (not shown as internal) to trigger the cameras to take images simultaneously.

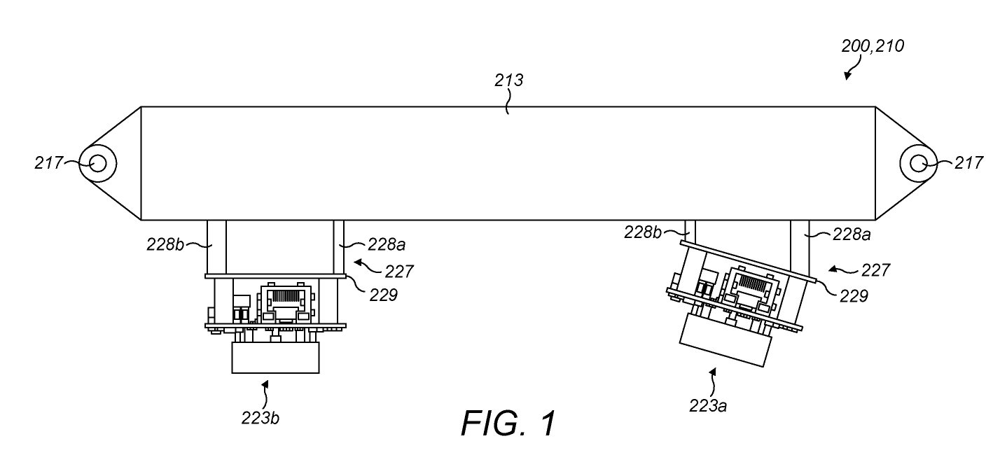

Each link, for example link 213 as shown in FIG. 1 (other links being similar), is provided with two cameras 223a and 223b mounted toward each end of the link, to act as a stereo pair.

Each camera is mounted to the link 213 by an attachment device comprising a platform 219. Each camera is attached to an outward-facing side of the platform 219. Two adjustable legs 228a and 228b are attached at opposite ends of the inward-facing side of the platform 229 and are attached to the link 213. The lengths of the legs 228a and 228b are adjustable so that the angle of the platform 229 (and therefore the camera 223a or 223b on it) can be changed. For example, camera 223b is angled straight (at 90 degrees to the link) and the legs 228a and 228 are the same height as each other. As an alternative configuration, camera 223a is angled towards the left hand side as shown in FIG. 1. This is achieved by the lengthening of leg 228a and the shortening of leg 228b. This adjustment of the camera angle can be done prior to any measuring/data capture to optimise the overlap between the field of view of the cameras. This is optimised based on the accuracy/resolution required and the quality of the lenses/cameras being used.

A lightweight lighting rig (not shown) is also provided attached to each camera to provide adequate ambient lighting to aid accurate measurement.

The far right hand end of the links (not shown) is attached to a robotic arm base, which is moveable along the direction of the wing (in and out of the page as shown in FIG. 2).

In use, the robotic arm 210 is swept across the wing 100 (in and out of the page as shown in FIG. 2) so as to capture data from the top surface 101 and leading edge surface 103. It is swept across by moving of its base (not shown) in the direction along the wing 100. As it is swept across the wing 100, the actuator mechanism actuates the pivotal connection 217 between the links 211-216 to configure the robotic arm 210 in variety of required pre-programmed configurations. The internal positioning tracking mechanism tracks the relative position of the links 211-216 and ensures the links are in the required position according to the swept position of the arm 210 across the wing 100.

As the robotic arm 210 is swept across the wing 100, the cameras 220 are triggered at the required locations by the trigger mechanism to trigger simultaneously. Thus, a collection of image data across the length and width of the wing is gathered. By linking this data with the positioning data of the links and cameras, it is possible, using post-processing by a computer, to give a surface profile of the wing surfaces 101, 103 and an indication of their smoothness. This can be used to establish whether the surface passes or fails a pre-set smoothness criteria for laminar flow.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

Deployment of the “links” may be done using any suitable means, and is not limited to use of a robotic arm. It may, for example, be done by the “links” being pivotally attached separately to a frame structure (forming separately mounted segments, rather than links).

The cameras could in fact be any suitable sensor, including a temperature sensor for measuring a temperature profile of the surface.

In the case of measuring temperature, a lighting rig may not be required.

If a lighting rig is required, it could be instead mounted to the links (or segments) rather than the sensors themselves. The lighting rig could be mounted separately. These give more flexibility of where lighting is placed (which may be needed, for example, for more challenging surfaces).

The positioning tracking of the links (or segments) may instead be provided by a mechanism separate to the actuation mechanism but still within the measuring apparatus. Alternatively, the positioning tracking of the links (or segments) may be performed by an external device.

At least one segment (or link) may be provided only with a single sensor.

The sensors may not be moveably mounted with respect to the link/segment.

The sensor(s) may be moveably mounted to the link/segment so as to be able to be twisted relative to the link/segment.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

What is claimed is:

1. A measuring apparatus for measuring properties of a surface, the apparatus comprising:
a mounting structure comprising a plurality of segments moveably mounted with respect to each other,
an actuation mechanism to move the segments of the mounting structure with respect to each other, and
a plurality of sensors, each sensor being mounted to a segment of the mounting structure.

2. A measuring apparatus as claimed in claim 1, wherein the mounting structure is supported by a support base and wherein the support base is moveable so that the mounting structure can be swept over the surface being measured.

3. A measuring apparatus as claimed in claim 1, wherein the actuation mechanism controls movement of the segments based on the swept position of the mounting structure.

4. A measuring apparatus as claimed in claim 1, wherein the measuring apparatus further comprises a position tracking mechanism for tracking the positions of the segments with respect to each other.

5. A measuring apparatus as claimed in claim 1, wherein the segments are pivotally mounted with respect to each other.

6. A measuring apparatus as claimed in claim 1, wherein the segments are moveably connected to each other at their ends to form an articulated arm.

7. A measuring apparatus as claimed in claim 1, wherein the mounting structure comprises a frame structure wherein the segments are moveably mounted to the frame structure.

8. A measuring apparatus as claimed in claim 1, wherein at least one segment is provided with at least two sensors.

9. A measuring apparatus as claimed in claim 8, wherein the two sensors are provided towards opposite ends of the segment.

10. A measuring apparatus as claimed in claim 1, wherein the sensors are movably mounted on the segments.

11. A measuring apparatus as claimed in claim 10, wherein the sensors are pivotally mounted on the segments.

12. A measuring apparatus as claimed in claim 1, wherein the sensors are sensors for measuring surface dimensions.

13. A measuring apparatus as claimed in claim 12, wherein the sensors are sensors for measuring the smoothness/waviness of a surface.

14. A measuring apparatus as claimed in claim 12, wherein the measuring apparatus further comprises a lighting rig for illuminating the surface being measured.

15. A measuring apparatus as claimed in claim 1, wherein the sensors are sensors for measuring temperature.

16. A measuring apparatus as claimed in claim 1, wherein the measurement apparatus further comprises a trigger mechanism for triggering the sensors to make a measurement.

17. A measuring apparatus as claimed in claim 16, wherein the trigger mechanism is arranged to trigger the sensors when the mounting structure is moved into one or more required sweep positions.

18. A method of measuring properties of a surface, the method comprising the steps of:
providing a surface whose properties are to be measured,
providing a measuring apparatus comprising a mounting structure and a plurality of sensors mounted on the mounting structure,
providing the mounting structure in a first sweep position with respect to the surface,
providing the sensors in a first configuration with respect to each other,
using the sensors to take measurements of the surface when in the first configuration and when the mounting structure is in the first sweep position,
sweeping the mounting structure over the surface from the first surface position to a second surface position, the second position being different to the first position,
moving the sensors to a second configuration with respect to each other, the second configuration being different to the first configuration, and
using the sensors to take measurements of the surface when in the second configuration and when the mounting structure is in the second sweep position.

19. A method of measuring properties of a surface as claimed in claim 18, wherein the method further comprising the step of transferring measurement data from the sensors to a computer to be processed.

20. A method of measuring properties of a surface as claimed in claim 18, wherein the surface to be measured is an aerodynamic surface of an aircraft.
